(19) United States
(12) Patent Application Publication
(10) Pub. No.: US 2005/0086690 A1
(43) Pub. Date: Apr. 21, 2005

(54) Interactive, non-intrusive television advertising

(75) Inventors: Michael Gilfix, Austin, TX (US); Scott Lee Winters, Austin, TX (US); Tyron Jerrod Stading, Austin, TX (US)

Correspondence Address: Biggers & Ohanian, PLLC, 504 Lavaca, Suite 970, Austin, TX, 78701, US

(73) Assignee: INTERNATIONAL BUSINESS MACHINES CORPORATION, ARMONK, NY (US)

(21) Appl. No.: 10/687,239

(22) Filed: Oct. 16, 2003

(51) Int. Cl. H04N 5/445

(52) U.S. Cl. 725/42

(57) ABSTRACT

Delivering interactive non-intrusive advertising content, including receiving a selection signal indicating that a user has selected an item displayed on a television screen, the item having associated non-intrusive interactive advertising content; identifying the selected item; and displaying the associated non-intrusive interactive advertising content. Embodiments typically include receiving and storing advertising data that associates the selected item with a screen region and with interactive advertising content. Receiving the advertising data often includes receiving the advertising data encoded in a video signal that includes a video image of the item. In some embodiments, the advertising data is encoded in a digital data stream separate from a video signal, and receiving the advertising data is carried out by receiving the data stream through a digital network. In typical embodiments, the advertising data includes instructions for control of the display of interactive non-intrusive advertising content for an item.

### BACKGROUND OF THE INVENTION

1. Field of the Invention

The field of the invention is data processing, or, more specifically, methods, systems, and products for delivering interactive non-intrusive television advertising.

2. Description of Related Art

Current television advertising is both intrusive for the viewer and costly for advertisers. Commercial breaks interrupt the flow of network programming, often annoy viewers, and encourage viewers to leave the television for breaks, a fact which is undesirable for both televisions networks and for advertisers. In addition, advertisers spend considerable money on film production for advertising and for hiring actors or celebrities to pitch products.

Since its original inception, the television advertising industry has changed little. At periodic intervals, televisions shows are interrupted for commercial breaks where a thirty second drama unfolds to pique consumer's interest. Consumer profiling is used to make products look more appealing to target audiences. Profiling often involves the use of celebrities to help elevate the status of a product, and the placing of commercials in time slots where the accompanying television shows appeal to the advertiser's target audience.

### SUMMARY OF THE INVENTION

The present invention enables delivery of advertising content associated with items displayed on a television screen with or without commercial interruptions of programs. Rather than pausing television programming for commercial breaks, advertising content may be delivered throughout the course of a television show. This is accomplished generally by providing an additional stream of advertising data that associates images of displayed items with advertising content describing the items. While watching a show, a consumer can use an input device such as a remote control to interactively flag items of interest and even place orders online.

Imagine an average consumer watching a popular television sitcom. Her favorite character comes on screen wearing a beautiful sweater. The viewer picks up her remote control, pauses the television show, moves a cursor across the screen to the sweater, and selects the desired sweater. A browser embedded in the television then pops up and brings her to the manufacturer's website, where she places an order for next day delivery. She then resumes watching her shown, which now spans near the full half-hour because the need for commercial breaks has been substantially reduced.

More particularly, this specification describes methods, systems, and products for delivering interactive non-intrusive advertising content that include receiving a selection signal indicating that a user has selected an item displayed on a television screen, wherein the item has associated non-intrusive interactive advertising content; responsive to receiving the selection signal, identifying the selected item; and displaying the associated non-intrusive interactive advertising content. Typical embodiments include receiving and storing advertising data that associates the selected item with a screen region and with interactive advertising content. Receiving the advertising data often is carried out by receiving the advertising data encoded in a video signal that includes a video image of the item. Alternatively, the advertising data is encoded in a digital data stream separate from a video signal and receiving the advertising data is carried out by receiving the data stream through a digital network. In typical embodiments, the advertising data includes instructions for control of the display of interactive non-intrusive advertising content for the item.

Many embodiments also include receiving one or more designation signals, wherein each designation signal represents an instruction to designate an item having associated non-intrusive interactive advertising content; and, responsive to receiving each designation signal, designating singly, as a currently designated item, each of a multiplicity of items having associated non-intrusive interactive advertising content; wherein identifying the selected item is carried out by identifying the currently designated item as the selected item. Designating singly each of a multiplicity of items typically includes logically designating an item and visually designating an item. Logically designating an item is typically accomplished by setting a designation data element in advertising data for the item. Visually designating an item may be accomplished by displaying descriptive text for the item or changing a video display of the item.

Some embodiments include tracking a cursor position on the television screen. In such embodiments, identifying the selected item is carried out by identifying the selected item in dependence upon the cursor position when the selection signal is received. Identifying the selected item in dependence upon the cursor position often includes determining whether the cursor position is within a screen region associated with the item.

In typical embodiments, interactive advertising content comprises a web page describing an item and offering an on-line sale of the item. Displaying associated non-intrusive interactive advertising content typically includes downloading a web page from a remote web site identified in a link associated with the selected item.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary television, a system improved according to embodiments of the present invention.

FIG. 2 sets forth is a line drawing of a remote control unit 210 useful with various embodiments of the present invention as a user input device.

FIG. 3 sets forth a flow chart illustrating an exemplary method for delivering interactive non-intrusive advertising content.

FIG. 4 is a line drawing of a television with a screen upon which are displayed items having associated non-intrusive interactive advertising content.

FIG. 5 sets forth a flow chart illustrating an additional exemplary method for delivering interactive non-intrusive advertising content.

FIG. 6 sets forth a flow chart illustrating a further exemplary method for delivering interactive non-intrusive advertising content.

### DETAILED DESCRIPTION OF EXEMPLARY EMBODIMENTS

Introduction

The present invention is described to a large extent in this specification in terms of methods for interactive non-intrusive television advertising. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

Definitions

A “URI” or “Universal Resource Identifier” is an identifier of a named object in any namespace accessible through a network. URIs are functional for any access scheme, including for example, the File Transfer Protocol or “FTP,” Gopher, and the web. A URI as used in typical embodiments of the present invention usually includes an internet protocol address, or a domain name that resolves to an internet protocol address, identifying a location where associated non-intrusive interactive advertising content is located on a network, often the Internet. Examples of associated non-intrusive interactive advertising content includes a web pages, CGI scripts, Java servlets, ASP pages, JSP pages, and so on. URIs directed to particular instances of associated advertising content, such as a particular web page, HTML file, CGI script, servlet, or the like, typically include a path name or file name locating and identifying a particular instance of advertising content in a file system connected through a server to a network. To the extent that a particular resource, such as a CGI file, a servlet, or a dynamic web page, is executable, for example to store or retrieve data, a URI often includes query parameters, or data to be stored, in the form of data encoded as part of the URI. Such parameters or data to be stored are referred to as ‘URI encoded data,’ or sometime as ‘form data.’

Form data is particularly useful in embodiments of the present invention to encode retrieval parameters identifying advertising content associated with a particular item displayed on a television screen. Such form data is packaged in a URI for data communications, a method for communicating variable names and values in a data processing system such as the Internet. Form data is typically communicated in hyperlinking protocols, such as, for example, HTTP which uses GET and POST functions to transmit URI encoded data. In this context, it is useful to remember that URIs do more than merely request file transfers. URIs identify resources, particularly interactive advertising content at locations on servers in cyberspace. Such advertising content may be in files having filenames, but the advertising content identified by URIs also may include, for example, queries to databases, including queries to search engines according to embodiments of the present invention. Results of such queries do not necessarily reside in files, but they are nevertheless data resources identified by URIs and identified by a search engine and query data that produce such resources. An example of URI encoded data is:
http://www.foo.com/cgi-bin/MyScript.cgi?field1=value1&field2=value2

This example shows a URI bearing encoded form data. The encoded form data is the string “field1=valuel&field2=value2.” The encoding method is to string field names and field values separated by ‘&’ and “=” with spaces represented by ‘+.’ There are no quote marks or spaces in the string. Having no quote marks, spaces are encoded with ‘+,’ and ‘&’ is encoded with an escape character, in this example, ‘%26.’For example, if an HTML form has a field called “name” set to “Lucy”, and a field called “neighbors” set to “Fred & Ethel”, the data string encoding the form would be:
name=Lucy&neighbors=Fred+%26+Ethel

An example of a URI bearing form data pertinent to embodiments of the present invention is the following:
www.ibm.com/cgi-bin/anAdvertisingScript.cgi?itemID=002

This example illustrated a CGI query to retrieve advertising content for a displayed item identified by item identifier ‘itemID’ of ‘002.’

“World Wide Web,” or more simply “the web,” refers to a system of internet protocol (“IP”) servers that support specially formatted, hyperlinking documents, documents formatted in markup languages such as HTML, XML, WML, and HDML. The term “web” is used in this specification also to refer to any server or connected group or interconnected groups of servers that implement a hyperlinking protocol, such as HTTP, WAP, HDTP, or others, in support of URIs and documents in markup languages, regardless whether such servers or groups of servers are connected to the World Wide Web as such.

“XML” stands for ‘extensible Markup Language,’ a language that support user-defined markup including user-defined elements, tags, and attributes. XML's extensibility contrasts with most web-related markup languages, such as HTML, which are not extensible, but which instead use a standard defined set of elements, tags, and attributes. XML's extensibility makes it a good foundation for defining other languages. WML, the Wireless Markup Language, for example, is a markup language based on XML. Modern browsers and other communications clients tend to support markup languages other than HTML, including, for example, XML.

Delivering Interactive Non-Intrusive Advertising Content

This specification describes methods, systems, and products for delivering interactive non-intrusive advertising content that operate generally by receiving a selection signal indicating that a user has selected an item displayed on a television screen (310), identifying (306) the selected item (316), and displaying associated non-intrusive interactive advertising content. The selection signal is typically a control signal generated by a remote control device operated by a user. The selected item typically associated non-intrusive interactive advertising content that is ‘associated’ in terms of relations among data structures. As discussed in more detail below, the data structures usually include both a data element identifying the item and a data element, such as a URI, identifying the location in cyberspace of the associated advertising content.

The advertising content is ‘non-intrusive’ in that it is not displayed to a user until the user requests it by selecting a displayed item having associated non-intrusive interactive advertising content. That the advertising content is both ‘associated’ and ‘non-intrusive’ signifies not only that the advertising content is not displayed until the user requests it, but that the advertising content is not even present in the television until the user requests it. The advertising content is ‘interactive’ in that it typically comprises a display of content amenable to user input, including selections of various levels of detail of description of the selected, where the selected item may be purchased, and even the opportunity immediately to purchase the selected item on-line.

In this specification, a television viewer who views or interacts with interactive non-intrusive advertising content is referred to as a ‘user.’ The user is advised generally which of the items displayed on a television screen at any particular time that have associated non-intrusive interactive content by a process referred to in this specification as ‘designation.’ In designation, the items on screen having associated non-intrusive interactive content are visually indicated typically one at a time in response to some user action. The user action is generally operation of controls on a remote control device that sends a ‘designation signal’ to the television. In response to the designation signal, the television highlights, circles, places a rectangle around, displays tooltip text or descriptive text for, or otherwise indicates to the user which items have associated non-intrusive interactive content. “Tooltip text” is descriptive text associated with an item that is used to describe the item and to indicate that the item has associated non-intrusive interactive content when the item is designated by a user.

Interactive advertising content preferably is implemented as a web page describing the item and offering an on-line sale of the item. Displaying associated non-intrusive interactive advertising content therefore often is carried out by downloading a web page from a remote web site identified in a ‘hyperlink.’ associated with the selected item. A hyperlink is sometimes referred to in this specification as a ‘link,’ a ‘resource locator,’ a URL, or a URI.

It is useful to distinguish early in this specification a designation signal from a selection signal. The designation signal is an indication that an item has been designated, in effect a request for the television set to advise the user whether the item has associated non-intrusive interactive content and is therefore available for selection. In systems supporting one-by-one designation of items, the item currently designated when a selection signal is received is typically identified as the selected item. The selection signal is an indication that an item has been selected, that is, effectively a request to display the associated non-intrusive interactive content.

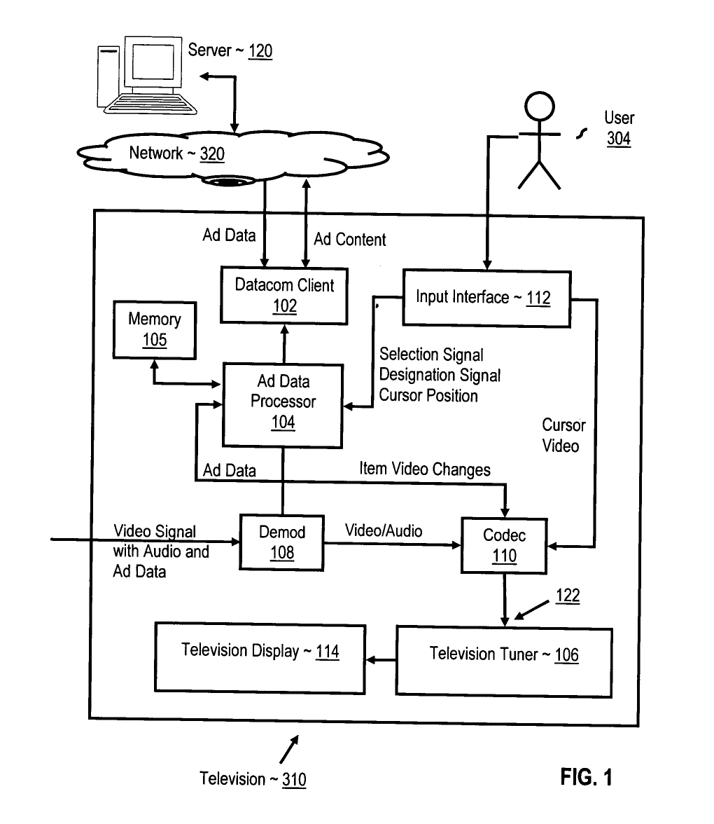

Methods, systems, and products for delivering interactive non-intrusive television advertising are now explained for exemplary embodiments with reference to the drawings, beginning with FIG. 1. FIG. 1 sets forth a block diagram of an exemplary television, a system improved according to embodiments of the present invention. Although components of a system embodying aspects of the present invention are depicted here as components of an improved television, persons of skill in the art will recognize that such components may be implemented in the form of a set-top box coupled to the television through at connection point 122 through an ordinary video cable. Other physical forms of such a system will occur to those of skill in the art, and all such forms are well within the scope of the present invention.

The television of FIG. 1 includes a demodulator 108 having as an input a video signal with encoded audio and advertising data. In this specification, unless the context requires otherwise, the term ‘video’ includes associated audio, which is typically carried on an integrated analog subcarrier, digitally encoded, or otherwise included with a video signal, whether digital or analog. Advertising data is the data structure and data values that associated displayed items with associated non-intrusive interactive advertising content. The diagram of FIG. 1 illustrates two ways of delivering advertising data to the television. The advertising data may integrated with into the video signal by, for example, modulating the advertising data on a separate subcarrier and then mixing the subcarrier so modulated with the main video signal. The advertising data may then be extracted and demodulated by demodulator 108 and then provided as digital data to an advertising data processor 104. In this kind of embodiment, a second output of the demodulator 108 is the ordinary video signal sent along the usual fashion to codec 110, now no longer bearing the subcarrier for the advertising data.

A “codec” is a video “encoder/decoder,” or perhaps more legibly, “coder/decoder”. Codecs are means and methods for encoding and decoding video, including video with audio. Codecs are implemented in hardware, in software, or in combinations of hardware and software. The codec illustrated at reference 110 in FIG. 1, shown as it is in a system or apparatus diagram, is implicitly a hardware codec. In terms of computer hardware, hardware codecs are considered types of computer co-processors for specialized video applications, and, like other co-processors, they tend to offload CPU burden (or advertising data processor 104 burden) and render overall television operation more efficient. There are many codecs, including, for example, Cinepak, Motion JPEG, and MPEG. Data processing operations among embodiments of the present invention are video-intensive, so that hardware codecs will be common in televisions and set-top boxes according to embodiments of the present invention, although the use of software codecs is also well within the scope of the present inventions and actually quite likely in a variety of cost-conscious embodiments. Moreover, although FIG. 1 illustrates only one codec 110, in actual implementations, one codec may be used to encode and decode more than one video format, or several codecs may be used in series to provide encodings of more than one video format as well as providing injection points for changes in video images of items, display of rectangles surrounding images of items, cursor images and cursor navigation, and so on.

Advertising data typically contains not only data that associates items with advertising content, but also data elements representing instructions for control of the display of advertising content. Such control instructions include, for example, an instruction to add an item to a list or table of items having associated interactive non-intrusive advertising content, an instruction to delete an item from such a table, an instruction to update the data for an item by for example changing data describing its display region on the television screen, an instruction to note that an item is now displayed (and is therefore available for designation and selection), and an instruction to note that an item is presently not displayed.

In typical embodiments of the present invention, such control instructions are synchronized with the appearance, removal, and locations changes of items displayed as video on the television display 114. When an item first appears in the video, therefore, associated advertising data includes an instruction to add to a list or table a data structure representing the item, identifying a screen region where the item is displayed, and noting that the item is presently displayed (and therefore available for designation and selection). When the item's screen location changes, its associated advertising data includes an instruction to update its data record with a new display screen region. When the item leaves the display, its associated advertising data includes an instruction to change its data record with an indication that the item is no longer on display (and therefore is not available for designation or selection.)

Another way of delivering advertising data to the television is through a digital data stream from a server 120 through a digital data communications network 320 to a data communication client 102 in the television. The server 120 may be a TCP server, an HTTP server, or other kinds of server as will occur to those of skill in the art. The network 320 may be an internet or the web. The data communications client 102 may be a TCP/IP client, a browser, or another data communications client as will occur to those of skill in the art. In a fashion similar to that described above for the advertising data embedded in the video stream, advertising data streamed as digital data, separate from the video, from a server 120 across a digital network 320 to a data communications client 102 also is synchronized with the movement in the video display, on and off the screen and around the screen, of items having associated interactive non-intrusive advertising content.

Persons of skill in the art will recognize that the television system of FIG. 1 may be implemented largely by computer components representing elements of automated computing machinery. More particularly, the advertising data processor 104 may be a computer processor, a central processing unit or ‘CPU,’ or a microprocessor. A control program (implementing inventive steps of the present invention) for the processor may be stored in computer memory 105, along with the advertising data associated advertising content with displayed items. Computer memory 105, along with other components, may be coupled to the processor 104 through a system bus (not shown). Computer memory may be represented by random access memory as well as various forms of non-volatile memory including for example, hard disk drives or microdrives, optical storage, electrically erasable programmable read-only memory space (so-called ‘EEPROM’ or ‘Flash’ memory), or as any other kind of computer memory as will occur to those of skill in the art.

The example television of FIG. 1 includes a codec 110. The codec 110 provides video and audio output to a usual television tuner 106. Codec 110 is a video encoder/decoder that provides normal video to television tuner 106, and can be used to encode on that normal video a cursor controlled through the user input interface 112 and changes in video display of items controlled through the advertising data processor 104.

The example television of FIG. 1 includes a user input interface 112. The user input interface 112 is a computer interface including, for example, conventional software drivers and computer hardware for controlling user input from user input devices such as remote control units, including designation signals, selection signals, and so on.

User input devices may includes not only remote control devices but also computer keyboards, computer mice, and others as will occur to those of skill in the art.

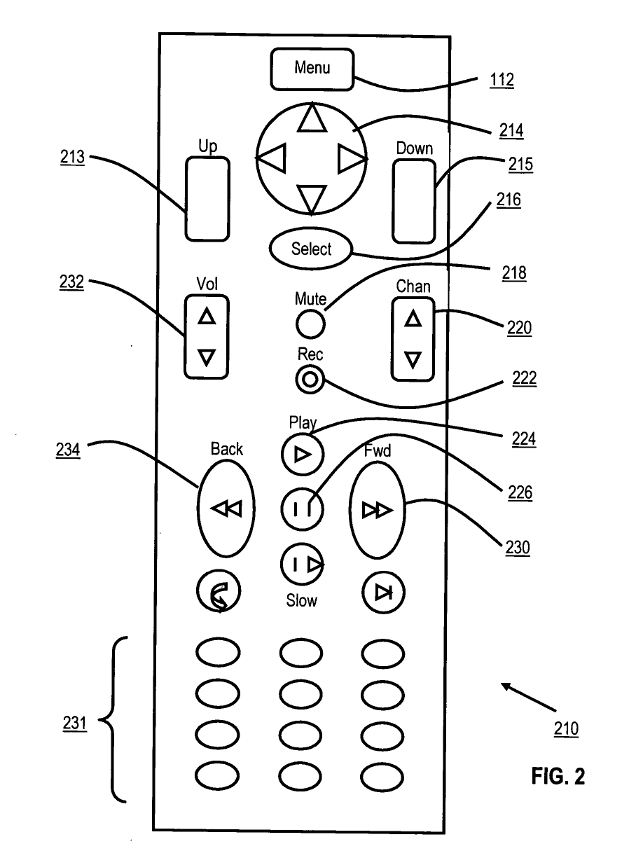

FIG. 2 sets forth is a line drawing of a remote control unit 210 useful with various embodiments of the present invention as a user input device. Similar to a standard remote control for a television, a DVD player, a VCR, or a personal video records, remote control unit 110 includes a “Menu” button for access to a central set of menus and data entry screens for configuring the television. The “Up” and “Down” buttons 213 and 215 allow users to scroll through configuration menus of through displays of available programming.

Navigation buttons 214 in typical embodiments of the present invention support designation of displayed items or cursor navigation controls. Signals from the remote control unit's navigation buttons, infrared signals or radio frequency signals, in some embodiments are interpreted by the television as instructions to designate a displayed item for an indication whether the item has associated non-intrusive interactive advertising content. Similarly, signals from the navigation buttons are interpreted by the television in some embodiments as navigation control signals for cursor positioning.

The “Select” button 216 typically is used to transmit a selection signal indicating to the television that a designated item is now selected for display of its associated non-intrusive interactive advertising content. Alternatively, the selection signal triggers a comparison of a cursor position with display screen regions associated with displayed items. In such embodiments, if the cursor position is in an associated screen region when a select button 216 is pressed, then the item associated with the screen regions is identified as the selected item.

The remote control unit includes conventional numeric keys 231 as well as buttons associated with television and recorded playback control including a “Volume” control 232, a “Channel” selector 220, a “Mute” button 218, and buttons for “Play” 224, a rewind button called “Back” 234, a fast forward button labeled “Fwd” 230, and a pause button 226. ‘Play,’ ‘Rewind,’ ‘Fast Forward,’ and ‘Pause’ are useful also for embodiments supporting video on demand or video sourced from a DVD player. Video on demand and DVD are preferred sources of video in embodiments of the present invention because they support pausing the video display—which tends to make designating and selecting items more convenient for users. The “Record” button 222 is used to instruct the television or an associated personal video recorder to record a television show.

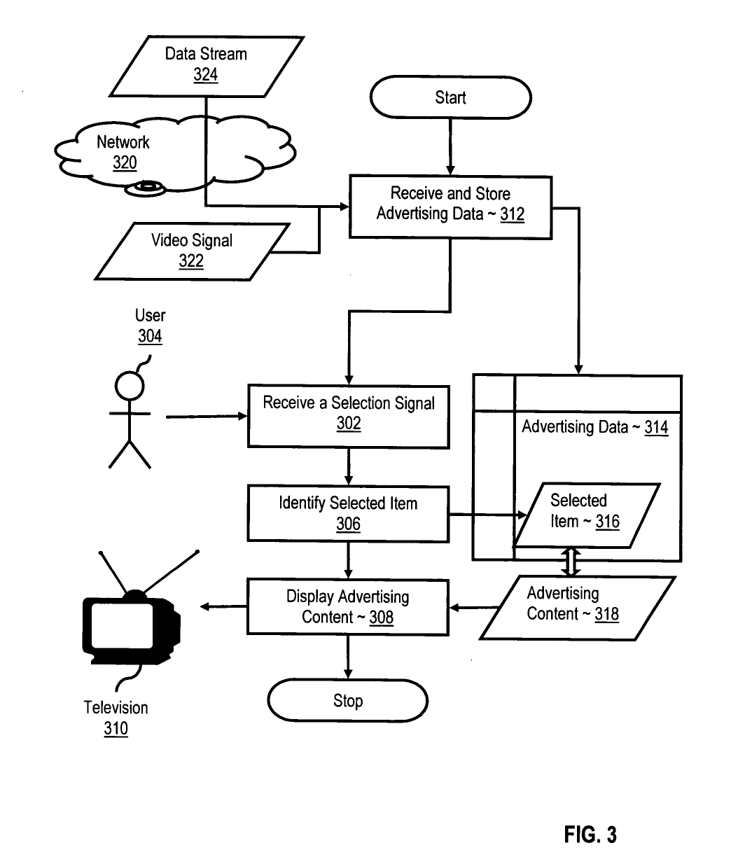

For further explanation, FIG. 3 sets forth a flow chart illustrating an exemplary method for delivering interactive non-intrusive advertising content that includes receiving 302 a selection signal indicating that a user 304 has selected an item displayed on a television screen 310. Interactive advertising content preferably is implemented as a web page describing the item and offering an on-line sale of the item. As mentioned earlier, advertising content is characterized as ‘non-intrusive’ because the advertising content is not displayed generally in the video until and unless a user operates a control device to select an item about which the user desires to know more or which the user desires to purchase.

As mentioned above, receiving a selection signal is typically carried out by receiving a selection signal in a television from a remote control device. In the method of FIG. 3, the selected item has associated with it non-intrusive interactive advertising content. The associated non-intrusive interactive advertising content is stored in computer memory on television 310 in a table as illustrated here in Table 1:

TABLE 1

| ItemID | screenRegion | Link | Displayed | Designated | Text |
|---|---|---|---|---|---|
| — | — | — | — | — | — |
| — | — | — | — | — | — |
| — | — | — | — | — | — |
| — | — | — | — | — | — |

Each row or record in Table 1 represents an item that may be displayed on the screen of television 310. Each record of Table 1 includes the following fields or data elements:

a field named “ItemID” which contains a unique identifier for a display item;

a field named “screenRegion” identifying the region of the screen where the item is displayed—if the item is currently displayed;

a field named “Link” that sets forth the location in cyberspace where associated advertising content is stored, typically set forth as a hyperlink or URI;

a field named “Displayed” containing a Boolean indication whether the item is currently displayed on the television screen;

a field named “Designated” containing a Boolean indication whether the item is currently designated; and

a field named “Text” containing a segment of tooltip text for the item.

ScreenRegion may be implemented as any set of screen coordinates identifying an area of the screen where an item is displayed. A typical implementation of screenRegion is, for example, a set of four screen coordinates defining a rectangle in which an item is displayed.

Because some embodiments of the present invention identify a selected item as the currently designated item, it is useful in such embodiments to have an indication in data whether an item is designated, such as the field named “Designated.” Readers may notice that this example contains no boolean indication whether an item is ‘Selected.’ This is because a selection signal is typically treated as an instruction to retrieve and display associated interactive non-intrusive advertising content. A selected item therefore is an item for which advertising content is currently on display, with typically no need to record that fact in the stored advertising data.

The method of FIG. 3 includes identifying 306 the selected item (316) in responsive to receiving the selection signal. It is useful to note that the selection signal itself is merely an indication that a user has made a selection; it contains no identification of which item has been selected. Systems implementing embodiments of the present invention therefore typically must utilize other data elements to carry out an identification of the selected item. In systems that support item indications with a cursor, for example, the cursor position can be compared to screen regions for items. If the cursor is in a screen region for an item when the selection signal is received, then that item is identified as the selected item. In systems supporting one-by-one designation of items, the item currently designated when a selection signal is received may be taken as the selected item.

The method of FIG. 3 also includes displaying 308 the associated non-intrusive interactive advertising content. As mentioned earlier, interactive advertising content preferably is implemented as a web page describing the item and offering an on-line sale of the item. Displaying associated non-intrusive interactive advertising content therefore often is carried out by downloading a web page associated with the selected item from a web site identified in a hyperlink or a URI from a field such as the “Link” field in Table 1.

The method of FIG. 3 also includes receiving 312 and storing advertising data 314 that associates the selected item with a screen region and with interactive advertising content. Receiving 312 advertising data 314 may be carried out by receiving the advertising data encoded in a video signal 322 that includes a video image of the item. The video signal can be from a broadcast channel, a cable channel, video on demand from a cable channel, from a DVD, or from any other source of video as may occur to those of skill in the art. Video on demand and DVD are preferred sources because they support pausing the video display—which tends to make designating and selecting items more convenient for users. As an alternative to encoding advertising data in video, advertising data may be encoded in a digital data stream 324 separate from a video signal. In such embodiments, receiving the advertising data is accomplished by receiving the digital data stream through a digital network 320.

In methods according to FIG. 3, advertising data typically includes instructions for control of the display of interactive non-intrusive advertising content for the item. Such advertising may be encoded in XML (the eXtensible Markup Language) as shown in the following example:

```
<item id=“001”>
    <screenRegion>5 10 5 20 10 10 10 20</screenRegion>
    <link>www.ibm.com/cgi-bin/
    someSalesScript.cgi?itemID=002</link>
    <displayed>YES</displayed>
    <designated>NO</designated>
    <action>
        ADD|DELETE|UPDATE|DISPLAYED-ON|
        DISPLAYED-OFF
    </action>
</item>
```

This example encodes in an XML element named <item> data associating an item with a screen region and a link to associated advertising content. The identify of the item is encoded in the ‘id’ parameter, in this example, as item number ‘001.’ The associated screen region is encoded in the subelement named <screenRegion>. In this example, the screen region is encoded as rows and columns defining the corners of a rectangle, where the string “5 10 5 20 10 10 10 20” encodes the corners as row 5, column 10; row 5 column 20; row 10 column 10; and row 10, column 20. This item encodes a link to associated advertising content as:
<link>www.ibm.com/cgi-bin/someSalesScript.cgi</link>

This example encodes the fact that the item is currently displayed as:
<displayed>YES</displayed>

This example encodes the fact that the item is not currently designated as
<designated>NO</designated>

In addition to encoding data associating an item with a screen region and a link to associated advertising content, this example represents advertising data that includes instructions for control of the display of interactive non-intrusive advertising content for the item. The instructions for control of the display of interactive non-intrusive advertising content are encoded in an XML element named <action>:

```
<action>
    ADD|DELETE|UPDATE|DISPLAYED-ON|
    DISPLAYED-OFF
</action>
```

In this example, supported alternative instructions are represented with the ‘|’ vertical bar separator. In this example, the supported alternative instructions include:

an ADD instruction to add an item to a list or table of items having associated interactive non-intrusive advertising content,

a DELETE instruction to delete an item from such a table,

an UPDATE instruction to update the data for an item by, for example, changing data describing its display region on the television screen,

a DISPLAY-ON instruction to note that an item is now displayed (and is therefore available for designation and selection), and

a DISPLAY-OFF instruction to note that an item is presently not displayed.

Note for further explanation that there is no supported instruction code to designate or select an item in this example. All the instructions codes illustrated here are communicated in advertising data streamed from a digital source or demodulated from a video source. There is no action code in advertising data to designate or select an item because an instruction to designate an item or to select an item comes from a user through a user input device or remote control device, not from advertising data.

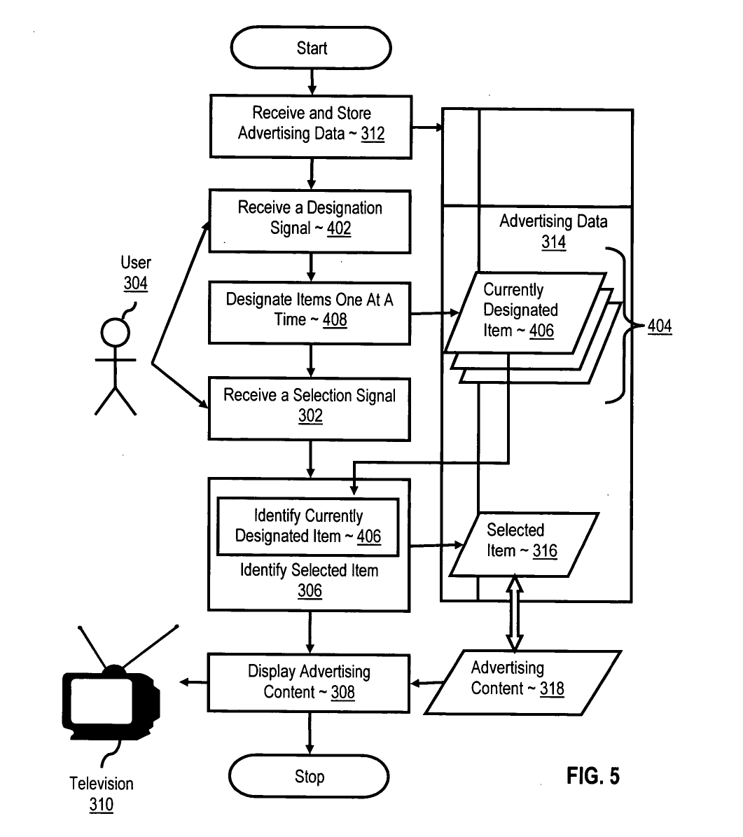

For further explanation, FIG. 5 sets forth a flow chart illustrating an additional exemplary method for delivering interactive non-intrusive advertising content that includes receiving 402 one or more designation signals, wherein each designation signal represents an instruction to designate an item having associated non-intrusive interactive advertising content. The method according to FIG. 5 also includes responding to receiving each designation signal by designating (408) singly, as a currently designated item (406), each of a multiplicity of items having associated non-intrusive interactive advertising content. That is, items currently displayed are designated one-by-one in turn, with highlighting, rectangles surrounding the items, tooltip text describing the items, and so on, as a user operates a remote control repeatedly to send designation signals one after another to the television. In other words, as the user repeatedly presses a button on the remote control, the television steps from one item to the next, indicating visually for each in turn that it is an item having associated interactive non-intrusive advertising content.

In typical embodiments of the kind illustrated in FIG. 5, designating 408 singly each of a multiplicity of items typically includes logically designating an item and visually designating an item. Visually designating an item may include displaying descriptive text (tooltip text) for the item, or changing a video display of the item including surrounding the item with a rectangular border on the television display, changing the brightness of the television display in the screen region of the item, or other means as will occur to those of skill in the art.

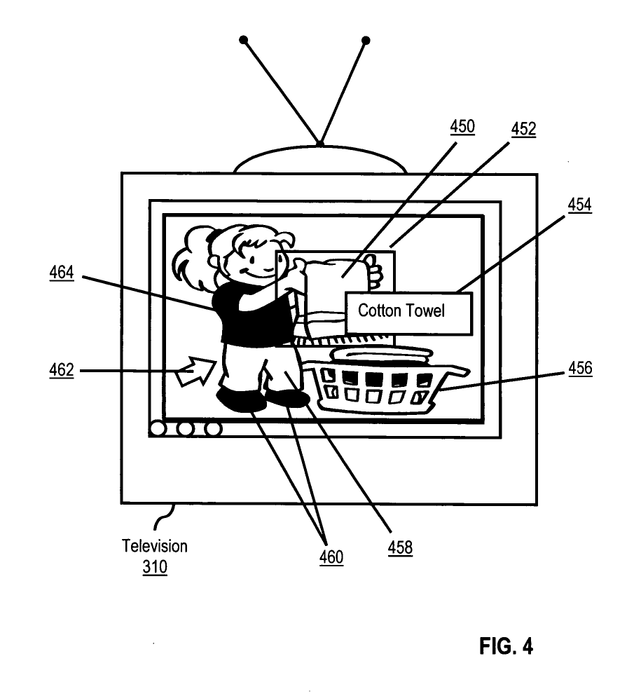

Consider the items displayed on the television screen in FIG. 4 for further explanation of visual designations. In the example of FIG. 4, several items having associated interactive non-intrusive advertising content are displayed: a sweater 464, a pair of pants 458, a pair of shoes 460, a cotton towel 450, and a laundry basket 456. Refer to Table 2 below and assume that the ‘Text’ field for item 002 contains the tooltip text string, “Cotton Towel.” FIG. 4 then illustrates ways of visually designating the cotton towel as a designated item, including surrounding it with a rectangle 452 and displaying its tooltip text 454, “Cotton Towel.” It addition, such embodiments often support changing the video display of the towel, as, for example, in brightening the area inside the rectangle defining an associated screen region for the towel. Such changes in the screen display may be implemented, in terms of the components of FIG. 1, by providing from an advertising data processor 104 to a codec 110 the required video changes to effect display of a rectangle, display of tooltip text, brightening the area in side a rectangle, and so on.

Logically designating an item typically includes setting a designation data element in advertising data for the item. In Table 2, for example,

TABLE 2

| | | | | Desig- | |
|---|---|---|---|---|---|
| ItemID | screenRegion | Link | Displayed | nated | Text |
| 001 | — | — | — | — | — |
| 002 | 5 10 5 20 10 | www.ibm.com/ | YES | YES | — |
| | 10 10 20 | cgi/aScript.cgi? | | | |
| | | itemID=002 | | | |
| 003 | — | — | — | — | — |
| — | — | — | — | — | — |

the item identified by itemID=002 has its ‘Designated’ field set to ‘YES,’ indicating that that item is currently designated. In systems supporting one-by-one designation of items, the item currently designated when a selection signal is received typically is identified as the selected item. This is the case in the example of FIG. 5, where identifying 308 the selected item 316 is carried out by identifying the currently designated item 406 as the selected item. In such embodiments, it is therefore preferred to designate only one item at a time. It is therefore also usual in such embodiments, upon receiving a subsequent designation signal, to reset a previous logical designation to NO or FALSE before setting a next item's logical designation to YES or TRUE.

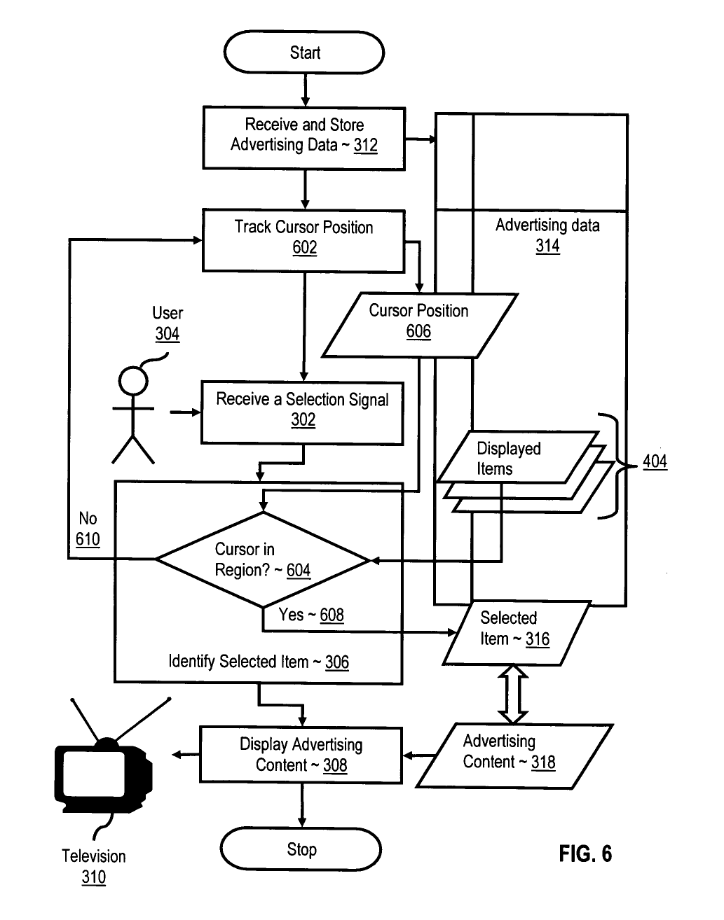

For further explanation, FIG. 6 sets forth a flow chart illustrating a further exemplary method for delivering interactive non-intrusive advertising content that includes tracking 602 a cursor position on a television screen. In the method of FIG. 6, identifying 306 a selected item is carried out by identifying the selected item in dependence upon the cursor position when the selection signal is received. More particularly, in the method of FIG. 6, identifying the selected item in dependence upon the cursor position typically is carried out by determining 604 whether the cursor position is within a screen region associated with the item. If the cursor position when a selection signal is received is within the screen region associated with a displayed item 404, then 608 that item is identified as the selected item 316.

If the cursor when a selection signal is received is not within a screen region associated with any displayed item 404, then 610 processing continues to track the cursor position 602. In effect, the fact that the cursor is not within a screen region associated with any displayed item when a selection signal is received typically means that a user pressed a select button when the cursor was not over the displayed image of an item. In the method of FIG. 6, processing loops to track the cursor until the user presses the select button when the cursor is over the image (or within the display region surrounding and overlaying the image) of a displayed item.

Remote control signals for cursor control may be provided by operation of navigation buttons on remote control devices such as those shown at reference 214 on FIG. 2. Signals from the remote control unit's navigation buttons, infrared signals or radio frequency signals, in such embodiments are interpreted by the television as navigation control signals for cursor positioning. The “Select” button (216 on FIG. 2) in such embodiments triggers the comparison of a cursor position with display screen regions associated with displayed items. In such embodiments, as described above, if the cursor position is in an associated screen region when a select button 216 is pressed, then the item associated with the screen regions is identified as the selected item.

Such remote control signals for cursor control are typically received in a television's user input interface such as the one illustrated at reference 112 on FIG. 1. Such a user interface converts infrared or radio frequency cursor control signals into a video representation of a cursor and cursor movement and provides the video representation of the cursor to a codec 110 for inclusion in the video signal to be displayed through a television tuner 106 on a television screen 114.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for delivering interactive non-intrusive advertising content, the method comprising:
receiving a selection signal indicating that a user has selected an item displayed on a television screen, wherein the item has associated non-intrusive interactive advertising content;
responsive to receiving the selection signal, identifying the selected item; and
displaying the associated non-intrusive interactive advertising content.

2. The method of claim 1 further comprising receiving and storing advertising data that associates the selected item with a screen region and with interactive advertising content.

3. The method of claim 2 wherein receiving the advertising data comprises receiving the advertising data encoded in a video signal that includes a video image of the item.

4. The method of claim 2 wherein the advertising data is encoded in a digital data stream separate from a video signal and receiving the advertising data comprises receiving the data stream through a digital network.

5. The method of claim 2 wherein the advertising data includes instructions for control of the display of interactive non-intrusive advertising content for the item.

6. The method of claim 1 further comprising:
receiving one or more designation signals, wherein each designation signal represents an instruction to designate an item having associated non-intrusive interactive advertising content;
responsive to receiving each designation signal, designating singly, as a currently designated item, each of a multiplicity of items having associated non-intrusive interactive advertising content;
wherein identifying the selected item comprises identifying as the selected item the currently designated item.

7. The method of claim 6 wherein designating singly each of a multiplicity of items further comprises logically designating an item and visually designating an item.

8. The method of claim 7 wherein logically designating an item comprises setting a designation data element in advertising data for the item.

9. The method of claim 7 wherein visually designating an item comprises displaying descriptive text for the item.

10. The method of claim 4 wherein visually designating an item comprises changing a video display of the item.

11. The method of claim 1 further comprising tracking a cursor position on the television screen, wherein identifying the selected item comprises identifying the selected item in dependence upon the cursor position when the selection signal is received.

12. The method of claim 1 further wherein identifying the selected item in dependence upon the cursor position further comprises determining whether the cursor position is within a screen region associated with the item.

13. The method of claim 1 wherein the interactive advertising content comprises a web page describing the item and offering an on-line sale of the item.

14. The method of claim 1 wherein displaying the associated non-intrusive interactive advertising content comprises downloading a web page from a remote web site identified in a link associated with the selected item.

15. A system for delivering interactive non-intrusive advertising content, the system comprising:
means for receiving a selection signal indicating that a user has selected an item displayed on a television screen, wherein the item has associated non-intrusive interactive advertising content;
operable in response to receiving the selection signal, means for identifying the selected item; and
means for displaying the associated non-intrusive interactive advertising content.

16. The system of claim 15 further comprising means for receiving and means for storing advertising data that associates the selected item with a screen region and with interactive advertising content.

17. The system of claim 16 wherein means for receiving the advertising data comprises means for receiving the advertising data encoded in a video signal that includes a video image of the item.

18. The system of claim 16 wherein the advertising data is encoded in a digital data stream separate from a video signal and means for receiving the advertising data comprises means for receiving the data stream through a digital network.

19. The system of claim 16 wherein the advertising data includes instructions for control of the display of interactive non-intrusive advertising content for the item.

20. The system of claim 15 further comprising:
means for receiving one or more designation signals, wherein each designation signal represents an instruction to designate an item having associated non-intrusive interactive advertising content;
operable in response to receiving each designation signal, means for designating singly, as a currently designated item, each of a multiplicity of items having associated non-intrusive interactive advertising content;
wherein means for identifying the selected item comprises means for identifying as the selected item the currently designated item.

21. The system of claim 20 wherein means for designating singly each of a multiplicity of items further comprises means for logically designating an item and means for visually designating an item.

22. The system of claim 21 wherein means for logically designating an item comprises means for setting a designation data element in advertising data for the item.

23. The system of claim 21 wherein means for visually designating an item comprises means for displaying descriptive text for the item.

24. The system of claim 21 wherein means for visually designating an item comprises means for changing a video display of the item.

25. The system of claim 15 further comprising means for tracking a cursor position on the television screen, wherein means for identifying the selected item comprises means for identifying the selected item in dependence upon the cursor position when the selection signal is received.

26. The system of claim 15 further wherein means for identifying the selected item in dependence upon the cursor position further comprises means for determining whether the cursor position is within a screen region associated with the item.

27. The system of claim 15 wherein the interactive advertising content comprises a web page describing the item and offering an on-line sale of the item.

28. The system of claim 15 wherein means for displaying the associated non-intrusive interactive advertising content comprises means for downloading a web page from a remote web site identified in a link associated with the selected item.

29. A computer program product for delivering interactive non-intrusive advertising content, the computer program product comprising:
a recording medium;
means, recorded on the recording medium, for receiving a selection signal indicating that a user has selected an item displayed on a television screen, wherein the item has associated non-intrusive interactive advertising content;
operable in response to receiving the selection signal, means, recorded on the recording medium, for identifying the selected item; and
means, recorded on the recording medium, for displaying the associated non-intrusive interactive advertising content.

30. The computer program product of claim 29 further comprising means, recorded on the recording medium, for receiving and means, recorded on the recording medium, for storing advertising data that associates the selected item with a screen region and with interactive advertising content.

31. The computer program product of claim 30 wherein means for receiving the advertising data comprises means, recorded on the recording medium, for receiving the advertising data encoded in a video signal that includes a video image of the item.

32. The computer program product of claim 30 wherein the advertising data is encoded in a digital data stream separate from a video signal and means for receiving the advertising data comprises means, recorded on the recording medium, for receiving the data stream through a digital network.

33. The computer program product of claim 30 wherein the advertising data includes instructions for control of the display of interactive non-intrusive advertising content for the item.

34. The computer program product of claim 29 further comprising:
means, recorded on the recording medium, for receiving one or more designation signals, wherein each designation signal represents an instruction to designate an item having associated non-intrusive interactive advertising content;
operable in response to receiving each designation signal, means, recorded on the recording medium, for designating singly, as a currently designated item, each of a multiplicity of items having associated non-intrusive interactive advertising content;
wherein means for identifying the selected item comprises means, recorded on the recording medium, for identifying as the selected item the currently designated item.

35. The computer program product of claim 34 wherein means for designating singly each of a multiplicity of items further comprises means, recorded on the recording medium, for logically designating an item and means, recorded on the recording medium, for visually designating an item.

36. The computer program product of claim 35 wherein means for logically designating an item comprises means, recorded on the recording medium, for setting a designation data element in advertising data for the item.

37. The computer program product of claim 35 wherein means for visually designating an item comprises means, recorded on the recording medium, for displaying descriptive text for the item.

38. The computer program product of claim 35 wherein means for visually designating an item comprises means, recorded on the recording medium, for changing a video display of the item.

39. The computer program product of claim 29 further comprising means, recorded on the recording medium, for tracking a cursor position on the television screen, wherein means for identifying the selected item comprises means, recorded on the recording medium, for identifying the selected item in dependence upon the cursor position when the selection signal is received.

40. The computer program product of claim 29 further wherein means for identifying the selected item in dependence upon the cursor position further comprises means, recorded on the recording medium, for determining whether the cursor position is within a screen region associated with the item.

41. The computer program product of claim 29 wherein the interactive advertising content comprises a web page describing the item and offering an on-line sale of the item.

42. The computer program product of claim 29 wherein means for displaying the associated non-intrusive interactive advertising content comprises means, recorded on the recording medium, for downloading a web page from a remote web site identified in a link associated with the selected item.
